(19) United States
(12) Patent Application Publication
(10) Pub. No.: US 2017/0045799 A1
(43) Pub. Date: Feb. 16, 2017

(54) Optical Imaging Apparatus

(71) Applicant: Theia Limited, Zhubei City (TW)

(72) Inventor: Yu-Hsuan Lin, Zhubei City (TW)

(21) Appl. No.: 14/825,249

(22) Filed: Aug. 13, 2015

(51) Int. Cl. G02F 1/29; G02B 27/22; G02F 1/1343

(52) U.S. Cl. CPC G02F 1/29; G02F 1/13439; G02B 27/2242

(57) ABSTRACT

An optical imaging apparatus is provided. The optical imaging apparatus includes at least one imaging source and a light deflecting control device placed on the imaging source, wherein a plurality of light emitted from the imaging source is deflected by the light deflecting control device and concentrates on a plurality of imaging forming points which located in at least one plane so as to form a two-dimensional/three-dimensional (2D/3D) image.

### BACKGROUND OF THE INVENTION

Field of Invention

The present invention relates to an optical imaging apparatus, especially relates to an optical imaging apparatus for forming a real image in the air.

Description of Related Art

A display displays an image by emitting light using various methods. A light emission method used by a display often serves as a basis for determining the type of the display. Various researches are being competitively conducted on each light emission method in order to effectively control the luminance of emitted light and improve display quality. Apart from research conducted to control the luminance of light, research into a stereoscopic image display which displays a three-dimensional (3D) image by controlling an optical path has recently been drawing a lot of attention.

From above, some people having ordinary skill in the art disclose the techniques of forming real image in the air. However, the 3D imaging apparatus with these techniques have disadvantages of thicker size, and not meet the demand for thinner of electronic apparatus.

### SUMMARY OF THE INVENTION

One aspect of the invention is to provide an optical imaging apparatus. The optical imaging apparatus meets the demand for thinner of electronic apparatus.

To achieve the foregoing and other aspects, an optical imaging apparatus is provided. The optical imaging apparatus includes at least one imaging source and a light deflecting control device placed on the imaging source, wherein a plurality of light emitted from the imaging source is deflected by the light deflecting control device and concentrates on a plurality of imaging forming points which are located in at least one plane so as to form a two-dimensional/three-dimensional (2D/3D) image.

In one embodiment of the present invention, the light deflecting control device comprises a plurality of light deflecting control units which deflect the light emitted from the imaging source.

In one embodiment of the present invention, the light deflecting control device comprises at least two light deflecting control elements stacked with each other, and the light deflecting control units are arranged in the light deflecting control elements respectively.

In one embodiment of the present invention, the light deflecting control elements are a first prism sheet and a second prism sheet, and the light deflecting control units are a plurality of prisms.

In one embodiment of the present invention, the prisms on the first prism sheet are disposed to be perpendicular to the prisms on the second prism sheet.

In one embodiment of the present invention, each prism has a light-emitting surface with a light-emitting slope, and the light-emitting surfaces of the prisms have different light-emitting slopes to deflect the light emitted from the imaging source toward different directions.

In one embodiment of the present invention, the light deflecting control elements are a first pixel control element and a second pixel control element, and the light deflecting control units are a plurality of pixels.

In one embodiment of the present invention, the pixels have a plurality of liquid crystal layers, and the liquid crystal layers are controlled to deflect the light emitted from the imaging source toward different directions.

In one embodiment of the present invention, the light deflecting control units are a plurality of concaves filled with liquid crystal, and the concaves filled with liquid crystal are constituted to a concave array.

In one embodiment of the present invention, each concave has the shape of the prism, and the concaves with the shape of the prism have different light-emitting slopes.

In one embodiment of the present invention, the light deflecting control unit is a gradient index lens using liquid crystal, and the light deflecting control device is a gradient index liquid crystal optical device.

In one embodiment of the present invention, each light deflecting control unit comprises a first substrate, a second substrate, and at least two deflecting angle control electrodes. The first substrate comprises a first base and a high-resistance transparent electrode, wherein the high-resistance transparent electrode is disposed on the first base. The second substrate comprises a second base and a low-resistance transparent electrode, wherein the low-resistance transparent electrode are disposed on the second base. The deflecting angle control electrodes are attached on the high-resistance transparent electrode, wherein the deflecting angle control electrodes control the light emitted from the imaging source deflect toward different directions.

In one embodiment of the present invention, the imaging source is a display device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view illustrating an optical imaging apparatus according to a first embodiment of the present invention.

FIG. 1B is a side view illustrating the optical imaging apparatus depicted in FIG. 1A.

FIG. 2 is a schematic view illustrating an optical imaging apparatus according to a second embodiment of the present invention.

FIG. 3A is a schematic view illustrating an optical imaging apparatus according to a third embodiment of the present invention.

FIG. 3B is a schematic view illustrating liquid crystal layers in the light deflecting control element depicted in FIG. 3A.

FIG. 4 is a schematic view illustrating a light deflecting control element according to a fourth embodiment of the present invention.

FIG. 5 is a schematic view illustrating a light deflecting control unit according to a fifth embodiment of the present invention.

### DESCRIPTION OF EMBODIMENTS

Other features and advantages of the invention will be further understood from the further technological features disclosed by the embodiments of the invention wherein there are shown and described embodiments of this invention, simply by way of illustration of best modes to carry out the invention.

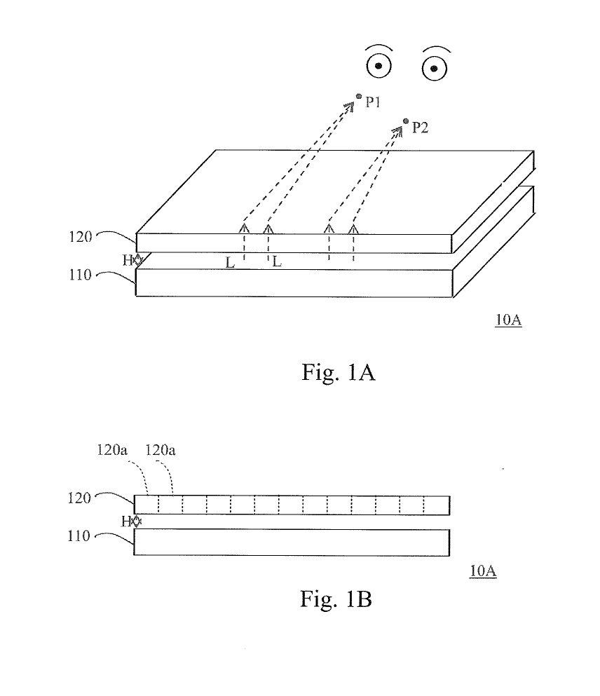

FIG. 1A is a schematic view illustrating an optical imaging apparatus according to a first embodiment of the present invention. FIG. 1B is a side view illustrating the optical imaging apparatus depicted in FIG. 1A. Please refer to FIG. 1A and FIG. 1B, the optical imaging apparatus 10A includes at least one imaging source 110 and a light deflecting control device 120 placed on the imaging source 110, wherein the imaging source 110 is a display device, for example. In addition, the light deflecting control device 120 can comprises a plurality of light deflecting control units 120a which deflect the light emitted from the imaging source 110. In the present invention, a plurality of light L emitted from the imaging source 110 is deflected by the light deflecting control device 120 and concentrates on a plurality of imaging forming points P1/P2. Further, the light L emitted from the imaging source 110 can be deflected by the light deflecting control units 120a of the light deflecting control device 120.

As shown in FIG. 1A, two imaging forming points P1/P2 are located in different planes so as to form a three-dimensional image. Worth mention, the imaging forming points as shown in FIG. 1A just takes two points for example. In practice, multiple imaging forming points can be formed to constitute a whole 3D image. In other preferred embodiment, the imaging forming points P1/P2 can located in the same plane. Therefore, a two-dimensional image also can be formed.

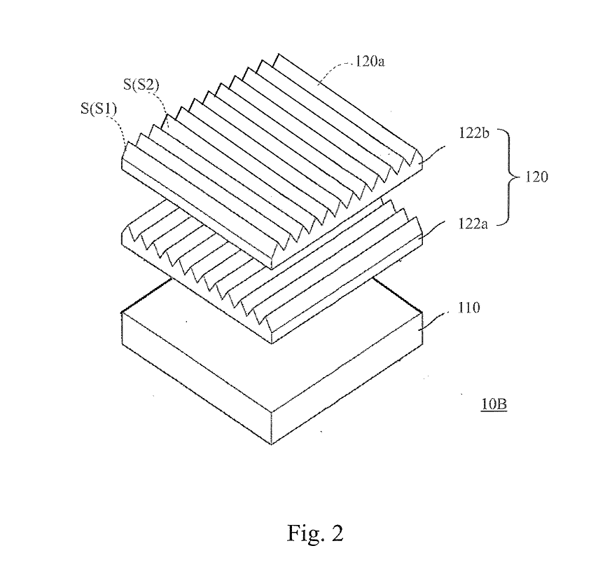

FIG. 2 is a schematic view illustrating an optical imaging apparatus according to a second embodiment of the present invention. Please refer to FIG. 2, in the optical imaging apparatus 10B of the second embodiment, the light deflecting control device 120 of the embodiment comprises at least two light deflecting control elements. In FIG. 2, the light deflecting control device 120 comprises two light deflecting control elements 122a and 122b, wherein the light deflecting control elements 122a and 122b are stacked with each other and the light deflecting control units 120a are arranged in the light deflecting control elements 122a and 122b respectively.

From above, the light deflecting control elements 122a and 122b are a first prism sheet and a second prism sheet respectively, and the light deflecting control units 120a are a plurality of prisms. That is, the prisms having triangle shaped cross sections are formed. In the embodiment of the present invention, the prisms on the first prism sheet are disposed to be perpendicular to the prisms on the second prism sheet. Here, the prisms on the first prism sheet and the prisms on the second prism sheet are extending to be perpendicular to each other, thereby concentrating light in horizontal and vertical directions.

Especially, in the embodiment of the present invention, each prism has a light-emitting surface S with a light-emitting slope, and the light-emitting surfaces S of the prisms have different light-emitting slopes to deflect the light emitted from the imaging source 110 toward different directions. In FIG. 2, one prism has a light-emitting surface S1 with a light-emitting slope, and another prism has a light-emitting surface S2 with a light-emitting slope, wherein the light-emitting slope of the light-emitting surface S2 is different from the light-emitting slope of the light-emitting surface S1. Therefore, the light emitted from the imaging source 110 can be deflected toward different directions and concentrates on the imaging forming points, like imaging forming points P1/P2 shown in FIG. 1A.

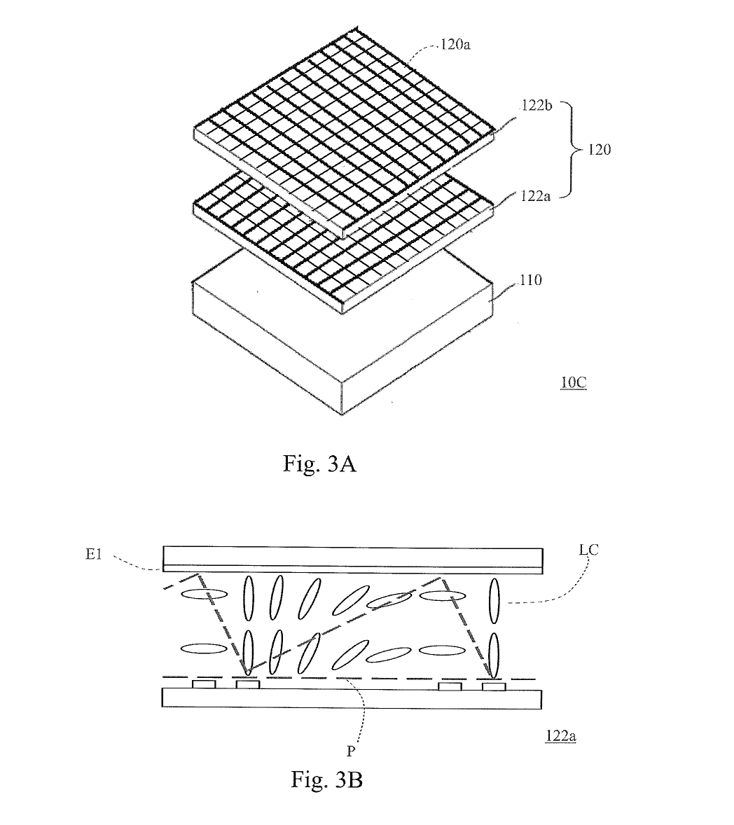

FIG. 3A is a schematic view illustrating an optical imaging apparatus according to a third embodiment of the present invention. FIG. 3B is a schematic view illustrating liquid crystal layers in the light deflecting control element depicted in FIG. 3A. Please refer to FIG. 3A and FIG. 3B, in the optical imaging apparatus 10C of the third embodiment, the light deflecting control elements 122a and 122b are a first pixel control element and a second pixel control element, and the light deflecting control units 120a are a plurality of pixels.

In the third embodiment of the present invention, the pixels have a plurality of liquid crystal layers LC, wherein the liquid crystal layers LC are controlled to deflect the light emitted from the imaging source 110 toward different directions and concentrates on the imaging forming points, like imaging forming points P1/P2 shown in FIG. 1A. Further, the liquid crystal layers LC in the light deflecting control element can be controlled by the electrodes E1, and then a structure of liquid crystal prisms P can be form to deflect the light emitted from the imaging source 110.

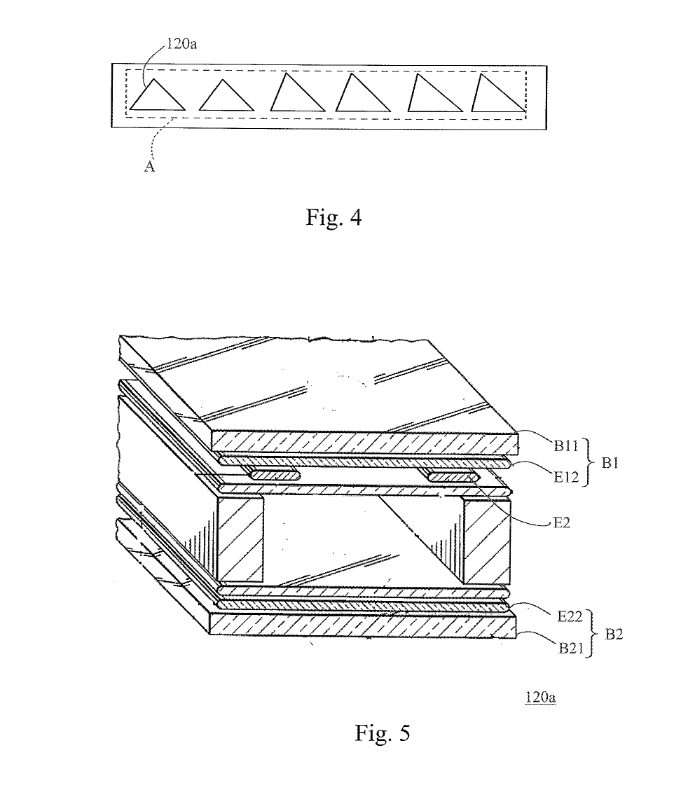

FIG. 4 is a schematic view illustrating a light deflecting control element according to a fourth embodiment of the present invention. Please refer to FIG. 4, in the fourth embodiment of the present invention, the light deflecting control units 120a are a plurality of concaves filled with liquid crystal, and the concaves filled with liquid crystal are constituted to a concave array A. In addition, each concave has the shape of the prism, and the concaves with the shape of the prism have different light-emitting slopes, like the design of the second embodiment.

FIG. 5 is a schematic view illustrating a light deflecting control unit according to a fifth embodiment of the present invention. Please refer to FIG. 5, in the fifth embodiment, the light deflecting control unit 120a is a gradient index lens using liquid crystal, and the light deflecting control device 120 is a gradient index liquid crystal optical device. Further, each light deflecting control unit 120a comprises a first substrate B1, a second substrate B2, and at least two deflecting angle control electrodes E2. The first substrate B1 comprises a first base B11 and a high-resistance transparent electrode E12, wherein the high-resistance transparent electrode E12 is disposed on the first base B11. In addition, the second substrate B2 comprises a second base B21 and a low-resistance transparent electrode E22, wherein the low-resistance transparent electrode E22 are disposed on the second base B21. The deflecting angle control electrodes E2 are attached on the high-resistance transparent electrode E12, wherein the deflecting angle control electrodes E2 control the light emitted from the imaging source deflect toward different directions and concentrates on the imaging forming points, like imaging forming points P1/P2 shown in FIG. 1A.

In addition, in other preferred embodiment, the amount of the deflecting angle control electrodes E2 can be four. That is, the deflecting angle control electrodes E2 can be attached on the high-resistance transparent electrode E12 in an array type of 2 by 2, so as to make the light deflect in air, further forming a two-dimensional/three-dimensional (2D/3D) image.

From above, the light emitted from the imaging source can be deflected by the light deflecting control device of the present invention, further controlling the light deflecting angle. Therefore, a gap H (shown in FIG. 1A and FIG. 1B) between the imaging source 110 and the light deflecting control device 120 can be keep closer. That is, the imaging apparatus of the present invention meets the demand for thinner of electronic apparatus.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An optical imaging apparatus, comprising:
at least one imaging source; and
a light deflecting control device, placed on the imaging source;
wherein a plurality of light emitted from the imaging source is deflected by the light deflecting control device and concentrates on a plurality of imaging forming points which located in at least one plane so as to form a two-dimensional/three-dimensional (2D/3D) image.

2. The optical imaging apparatus of claim 1, wherein the light deflecting control device comprising a plurality of light deflecting control units which deflect the light emitted from the imaging source.

3. The optical imaging apparatus of claim 2, wherein the light deflecting control device comprising at least two light deflecting control elements stacked with each other, and the light deflecting control units are arranged in the light deflecting control elements respectively.

4. The optical imaging apparatus of claim 3, wherein the light deflecting control elements are a first prism sheet and a second prism sheet, and the light deflecting control units are a plurality of prisms.

5. The optical imaging apparatus of claim 4, wherein the prisms on the first prism sheet are disposed to be perpendicular to the prisms on the second prism sheet. further comprising a non-transparent partition plate, wherein the non-transparent partition plate has a hole, the light emitted from the imaging source is incident on the micro reflective mirror array after passing through the hole.

6. The optical imaging apparatus of claim 4, wherein each prism has a light-emitting surface with a light-emitting slope, and the light-emitting surfaces of the prisms have different light-emitting slopes to deflect the light emitted from the imaging source toward different directions.

7. The optical imaging apparatus of claim 3, wherein the light deflecting control elements are a first pixel control element and a second pixel control element, and the light deflecting control units are a plurality of pixels.

8. The optical imaging apparatus of claim 7, wherein the pixels have a plurality of liquid crystal layers, and the liquid crystal layers are controlled to deflect the light emitted from the imaging source toward different directions.

9. The optical imaging apparatus of claim 3, wherein the light deflecting control units are a plurality of concaves filled with liquid crystal, and the concaves filled with liquid crystal are constituted to a concave array.

10. The optical imaging apparatus of claim 9, wherein each concave has the shape of the prism, and the concaves with the shape of the prism have different light-emitting slopes.

11. The optical imaging apparatus of claim 2, wherein the light deflecting control unit is a gradient index lens using liquid crystal, and the light deflecting control device is a gradient index liquid crystal optical device.

12. The optical imaging apparatus of claim 2, wherein each light deflecting control unit comprises:
a first substrate comprising a first base and a high-resistance transparent electrode, wherein the high-resistance transparent electrode is disposed on the first base;
a second substrate comprising a second base and a low-resistance transparent electrode, wherein the low-resistance transparent electrode are disposed on the second base; and
at least two deflecting angle control electrodes are attached on the high-resistance transparent electrode;
wherein the deflecting angle control electrodes control the light emitted from the imaging source deflect toward different directions.

13. The optical imaging apparatus of claim 1, wherein the imaging source is a display device.
